(19) United States
(12) Patent Application Publication
(10) Pub. No.: US 2010/0094545 A1
(43) Pub. Date: Apr. 15, 2010

(54) COMMUNICATION DEVICE AND METHOD FOR DOWNLOADING NAVIGATION MAPS

(75) Inventor: TUNG-WEI LIN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/507,166

(22) Filed: Jul. 22, 2009

(30) Foreign Application Priority Data
Oct. 10, 2008 (CN) 200810304873.6

(51) Int. Cl. G01C 21/00; G06F 17/30

(52) U.S. Cl. 701/208; 707/E17.108; 707/E17.018; 707/E17.005

(57) ABSTRACT

A communication device and method for downloading navigation maps include creating a database to store navigation maps, and acquiring position information of a location of the communication device. The communication device and method further include downloading a navigation map including the position information from a server if the database does not have stored navigation map including the position information, and storing the downloaded navigation map into the database.

### BACKGROUND

1. Technical Field

Embodiments of the present disclosure relate to downloading information, and more particularly to a communication device and method for downloading navigation maps into a communication device.

2. Description of Related Art

Communication devices may provide a navigation system. For example, people may find ways to a destination address using the navigation system. However, navigation systems often use stored maps in a communication device to provide routes to a determined destination. If there are no corresponding navigation maps in the communication device, the navigation system cannot provide an accurate navigation service to people.

What is needed, therefore, is an improved communication device and method for downloading navigation maps automatically.

### BRIEF DESCRIPTION OF THE DRAWINGS

FIG. 1 is a block diagram of one embodiment of a communication device in communication with a server through a plurality of base stations.

FIG. 2 is a block diagram of one embodiment of the communication device comprising a navigation system.

FIG. 3 is a flowchart of one embodiment of a method for downloading navigation maps into the communication device of FIG. 1.

FIG. 4 is a schematic diagram of one embodiment of a navigation map.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

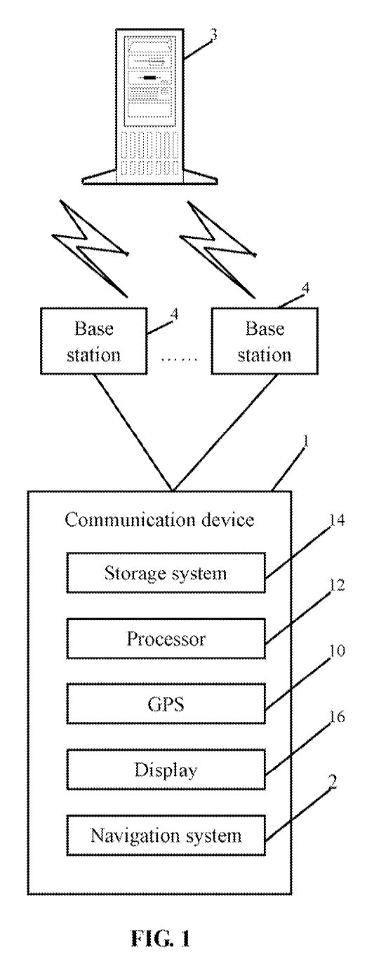

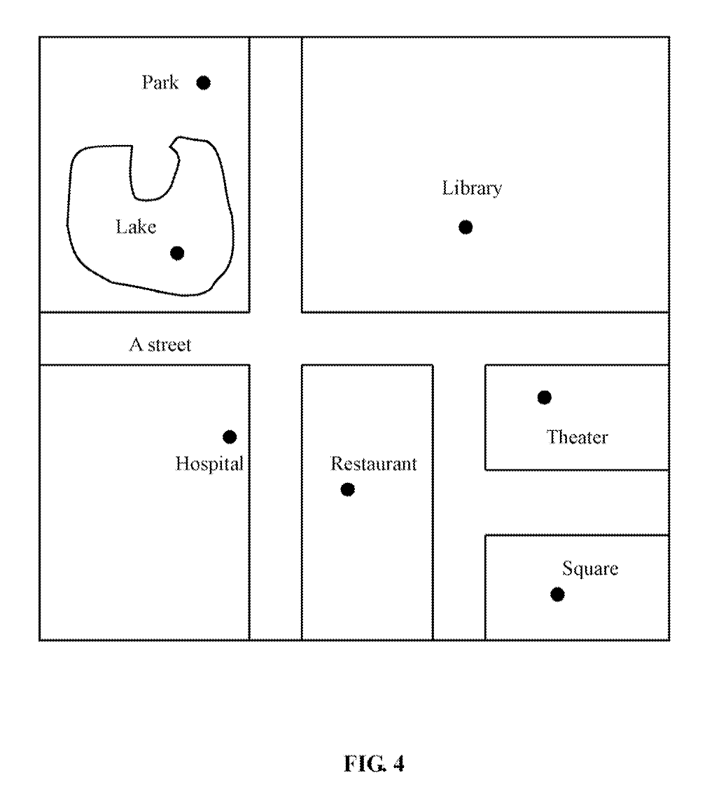

FIG. 1 is a block diagram of one embodiment of a communication device 1 in communication with a server 3 through a plurality of base stations 4. The communication device 1 may include a global position system (GPS) 10 and a navigation system 2. The GPS 10 may be used to locate the communication device 1. The navigation system 2 may be used to acquire position information of the communication device 1 from the GPS 10, and download a navigation map including the acquired position information from the server 3. Referring to FIG. 4, an example of a navigation map is shown.

In one embodiment, the server 3 is used to provide various navigation maps to people. The server 5 may be a host computer, for example. In one embodiment, the server 1 may be a web server, which provides a website including various webpages for people to register, browse, or upload/download navigation maps, for example.

The communication device 1 may be a mobile phone, a personal digital assistant (PDA), a handheld computer, or any other kind of computing device. In the embodiment as shown in FIG. 1, the communication device 1 may further include a processor 12, a storage system 14, and a display 16. The storage system 14 stores one or more programs, such as programs of an operating system, other applications of the communication device 1, and various kinds of data, such as navigation maps, position information, for example. In one embodiment, the storage system 14 may be a memory of the communication device 1 or an external storage card, such as a memory stick, a subscriber identification module (SIM) card, a smart media card, a compact flash card, or any other type of memory card. The processor 12 executes one or more computerized operations of the communication device 1 and other applications, to provide functions of the communication device 1. The display 16 may display various information, such as the navigation maps, for example.

In the embodiment of FIG. 1, the communication device 1 may communicate with the server 3 through a plurality of base stations 4. The base stations 4 may be wireless base stations or mobile telephone base stations, for example. A user of the communication device 1 may access the server 3 to upload/download navigation maps through the plurality of base stations 4.

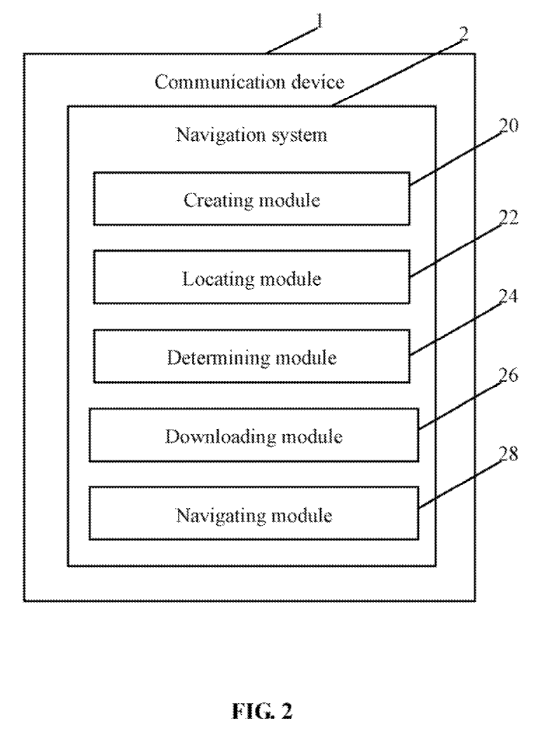

FIG. 2 is a block diagram of one embodiment of the communication device 1 including the navigation system 2. In one embodiment, the navigation system 2 includes a creating module 20, a locating module 22, a determining module 24, a downloading module 26, and a navigating module 28. The modules 20, 22, 24, 26, and 28 may comprise one or more computerized operations to be executed by the processor 10 to perform one or more operations of the communication device 1, such as to acquire position information from the GPS 10 and download a navigation map from the server 3.

The creating module 20 creates a database in the storage system 14 to store navigation maps. The navigation maps may include maps of various states, countries, amusements parks, and/or restaurants, for example.

The locating module 22 activates the GPS 10 when the navigation system 2 is activated, and acquires position information of a current location of the communication device 1 from the GPS 10. The position information may include longitude, latitude, and altitude of the location.

The determining module 24 determines if the database has a stored navigation map including the position information of the current location of the communication device 1 from the navigation maps in the database.

If the database does not have any stored navigation maps including the position information, the downloading module 26 searches the server 3 for a navigation map including the position information. If a navigation map including the positional information is found, the downloading module 26 downloads the navigation map including the position information from the server 3. The downloading module 26 further stores the downloaded navigation map into the database in the storage system 14.

In one embodiment, if the database has the stored navigation map including the position information, or if a navigation map including the position information has been downloaded, the navigating module 28 displays the stored/downloaded navigation map on the display 16 of the communication device 1, and provides navigational directions using the stored/downloaded navigation map. The provided navigational directions may be outputted to the display 16 and/or outputted via a speaker of the communication device 1.

In another embodiment, if the database has the stored navigation map including the position information, the downloading module 26 may also search the server 3 for a navigation map including the position information. If a navigation map including the position information is found in the server 3, the determining module 24 determines if a version of the found navigation map is a newer version than a version of the stored navigation map.

If the version of the found navigation map is a newer version than the version of the stored navigation map, the downloading module 26 deletes the stored navigation map from the database, and downloads the found navigation map into the database. If the version of the found navigation map is not a newer version than the version of the stored navigation map, the navigating module 28 displays the stored navigation map on the display 16 directly.

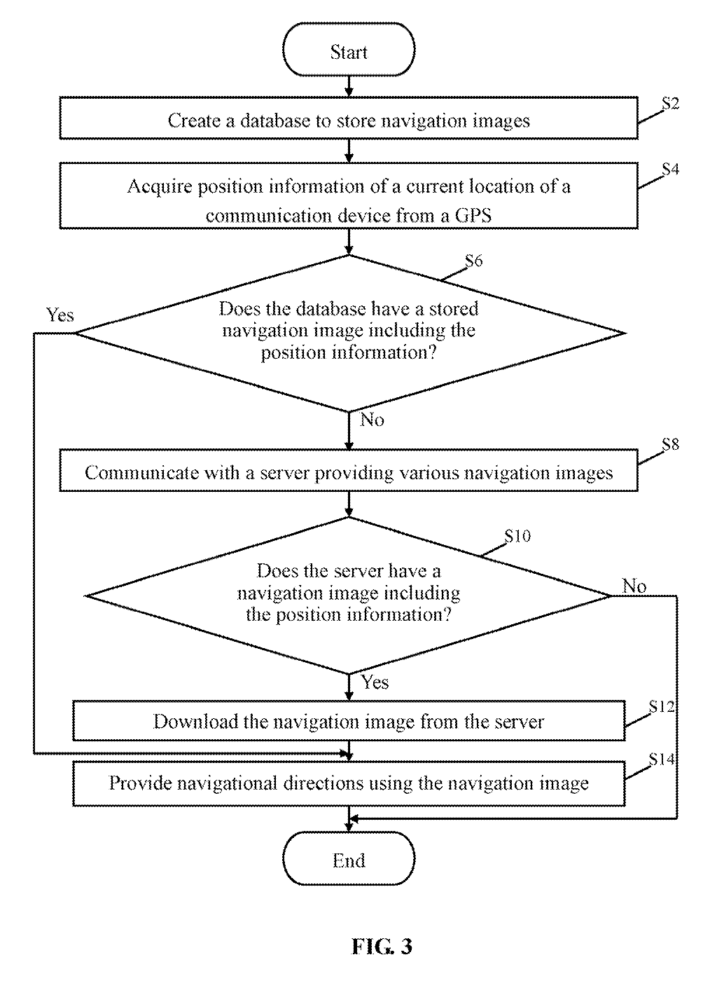

FIG. 3 is a flowchart of one embodiment of a method for downloading navigation maps into the communication device 1. Depending on the embodiment, additional blocks may be added, others removed, and the ordering of the blocks may be replaced.

In block S2, the creating module 20 creates a database in the storage system 14 to store navigation maps. As mentioned above, the navigation maps may include maps of various states, countries, amusements parks, and/or restaurants, for example.

In block S4, the locating module 22 activates the GPS 10 to locate a current location the communication device 1, and the locating module 22 acquires position information of the current location from the GPS 10. The position information may include longitude, latitude, and altitude of the location.

In block S6, the determining module 24 determines if the database has a stored navigation map including the position information of the current location of the communication device 1 from the navigation maps in the database. If the database has the stored navigation map including the position information, the procedure goes to block S14 directly.

If the database does not have any stored navigation map including the position information, in block S8, the communication device 1 communicates with the server 3 that provides various navigation maps.

In block S10, the downloading module 26 searches the server 3 and determines if the server 3 has a navigation map including the position information. If the server 3 does not have any navigation map including the position information, the procedure ends.

If the server 3 has a navigation map including the position information, in block S12, the downloading module 26 downloads the navigation map including the position information from the server 3, and stores the downloaded navigation map into the database in the storage system 14.

In block S14, the navigating module 28 displays the stored/downloaded navigation map on the display 16 of the communication device 1, and provides navigational directions using the stored/downloaded navigation map. As mentioned above, the provided navigational directions may be outputted to the display 16 and/or outputted via a speaker of the communication device 1.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for downloading navigation maps into a communication device, the communication device in communication with a server that provides the navigation maps, the method comprising:
creating a database in a storage system of the communication device to store navigation maps;
activating a global position system (GPS) of the communication device;
acquiring position information of a location of the communication device using the GPS;
determining if the database has a stored navigation map comprising the position information of the communication device from the navigation maps in the database;
downloading a navigation map comprising the position information of the communication device from the server, if the database does not have the stored navigation map comprising the position information of the communication device;
storing the downloaded navigation map into the database in the storage system.

2. The method according to claim 1, further comprising:
providing navigational directions using the downloaded navigation map.

3. The method according to claim 1, further comprising:
searching the server for a navigation map comprising the position information of the communication device, if the database has the stored navigation map comprising the position information;
determining if a version of a found navigation map is a newer version than a version of the stored navigation map;
deleting the stored navigation map from the database if the version of the found navigation map is a newer version than the version of the stored navigation map; and
downloading the found navigation map into the database.

4. The method according to claim 1, wherein the position information comprises longitude, latitude, and altitude of the location.

5. The method according to claim 1, wherein communication device communicates with the server through a plurality of base stations.

6. The method according to claim 5, wherein the plurality of base stations are wireless base stations or mobile telephone base stations.

7. A communication device, the communication device in communication with a server that provides navigation maps, the communication device comprising:
a storage system;
at least one processor; and
one or more programs stored in the storage system and being executable by the at least one processor, the one or more programs comprising:
a creating module operable to create a database in the storage system to store navigation maps;
a locating module operable to activate a global position system (GPS) of the communication device, and acquire position information of a location of the communication device using the GPS;
a determining module operable to determine if the database has a stored navigation map comprising the position information of the communication device from the navigation maps in the database; and
a downloading module operable to download a navigation map comprising the position information of the communication device from the server if the database does not have the stored navigation map comprising the position information of the communication device, and store the downloaded navigation map into the database in the storage system.

8. The communication device according to claim 7, where the one or more programs further comprise a navigating module operable to provide navigational directions using the downloaded navigation map.

9. The communication device according to claim 7, wherein:
the downloading module is further operable to search the server for a navigation map comprising the position information of the communication device if the database has the stored navigation map comprising the position information;
the determining module is further operable to determine if a version of a found navigation map is a newer version than a version of the stored navigation map; and
the downloading module is further operable to delete the stored navigation map from the database if the version of the found navigation map is a newer version than the version of the stored navigation map, and download the found navigation map into the database.

10. The communication device according to claim 7, wherein the position information comprises longitude, latitude, and altitude of the location.

11. The communication device according to claim 7, wherein the communication device communicates with the server through a plurality of base stations.

12. The communication device according to claim 11, wherein the plurality of base stations are wireless base stations or mobile telephone base stations.

13. A storage medium storing a set of instructions, the set of instructions capable of being executed by a processor to perform a method for downloading navigation maps into a communication device, the communication device in communication with a server that provides the navigation maps, the method comprising:
creating a database in a storage system of the communication device to store navigation maps;
activating a global position system (GPS) of the communication device;
acquiring position information of a location of the communication device using the GPS;
determining if the database has a stored navigation map comprising the position information of the communication device from the navigation maps in the database;
downloading a navigation map comprising the position information of the communication device from the server, if the database does not have the stored navigation map comprising the position information of the communication device;
storing the downloaded navigation map into the database in the storage system.

14. The storage medium as claimed in claim 13, wherein the method further comprises:
providing navigational directions using the downloaded navigation map.

15. The storage medium as claimed in claim 13, wherein the method further comprises:
searching the server for a navigation map comprising the position information of the communication device, if the database has the stored navigation map comprising the position information;
determining if a version of a found navigation map is a newer version than a version of the stored navigation map;
deleting the stored navigation map from the database if the version of the found navigation map is a newer version than the version of the stored navigation map; and
downloading the found navigation map into the database.

16. The storage medium as claimed in claim 13, wherein the position information comprises longitude, latitude, and altitude of the location.

17. The storage medium as claimed in claim 13, wherein communication device communicates with the server through a plurality of base stations.

18. The storage medium as claimed in claim 17, wherein the plurality of base stations are wireless base stations or mobile telephone base stations.
